(19) United States
(12) Patent Application Publication
(10) Pub. No.: US 2004/0078361 A1
(43) Pub. Date: Apr. 22, 2004

(54) System and method for analyzing patent families

(76) Inventors: Gaopeng Hu, Shenzhen (CN); Caiyang Luo, Shenzhen (CN); XiuMing Duan, Shenzhen (CN); Chung-I Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/335,427

(22) Filed: Dec. 30, 2002

(30) Foreign Application Priority Data
Oct. 18, 2002 (TW) 91124030

(51) Int. Cl. G06F 17/30

(52) U.S. Cl. 707/3

(57) ABSTRACT

A system for analyzing patent families includes client computers (10), an application server (12), and a local database (150). The client computers are connected to the application server via a network (11), and the application server is connected to the local database through database connectivity (13). The application server includes a patent downloading unit (120) and a patent family analyzing unit (122). A user sets patent family downloading conditions through a user interface (100) of any client computer. The patent-downloading unit automatically downloads corresponding patent family data from a patent family database (170), and returns the patent family data to the local database. Thereupon, the user sets patent family analysis conditions through the user interface. The patent family analyzing unit analyzes the patent family data stored in the local database according to the patent family analysis conditions. The analysis results are displayed for the user through the client computer.

### BACKGROUND OF THE INVENTION

1. Field of the Invention

The present invention relates to a system and method for managing patent data, and particularly to a system and method for analyzing groups of related patents known as patent families.

2. Background of the Invention

Patent family analysis plays an important role in comprehending competitors' product strategies and development in a particular technological field. For instance, patent family analysis of a particular company can help to analyze strategies of patent distribution and product development of the company. In addition, patent family analysis of a particular technological field can help to understand a state of development of the technology in various countries and regions.

Present-day patent family databases, such as the LexisNexis Corporation database, enable users to search patent family data by patent number or by company name at their websites. However, it is not convenient for general users to read the search results, because patent family data downloaded from the databases need to be further arranged. In addition, when a user selects patent numbers as one of the search conditions, it is laborious and time-consuming to input patent numbers one by one. Furthermore, when the scope of patents to be analyzed is very wide, a user needs to repeat the procedure of inputting patent numbers and analysis conditions several times. This is because the length of key words for searching is limited. Thus, a system and method for analyzing patent families which overcomes the above-mentioned problems is desired.

### SUMMARY OF THE INVENTION

Accordingly, a main objective of the present invention is to provide a system and method for conveniently analyzing patent family data and obtaining analysis results in readily readable form.

Another objective of the present invention is to provide a system and method for analyzing patent families, whereby a user can search patent family data easily.

To accomplish the above objectives, a system for analyzing patent families in accordance with a preferred embodiment of the present invention comprises a plurality of client computers, an application server and a local database. The client computers each include an interactive user interface, through which a user can set downloading conditions and analysis conditions for a patent family. The application server comprises a patent downloading unit for automatically downloading patents from at least one remote database according to patent downloading conditions, and for downloading patent family data from a patent family database according to patent family downloading conditions; a patent family analyzing unit for analyzing a patent family according to analysis conditions set for the patent family; and a controlling unit for controlling operations of the patent downloading unit and the patent family analyzing unit, and for coordinating interactions between the user and the patent downloading unit and the patent family analyzing unit. The controlling unit accepts patent family downloading conditions, transfers the downloading conditions to the patent downloading unit, and displays downloading results for the user through the user interface. The controlling unit accepts analysis conditions for a patent family to be analyzed, transfers the analysis conditions to the patent family analyzing unit, and transmits analysis results to the relevant client computer. The local database is used for storing downloaded patents and patent family data. The client computers are connected to the application server via a network, and the application server is connected to the local database through database connectivity.

Further, the present invention provides a method for analyzing patent families, the method comprising the steps of: (a) setting patent downloading conditions through a user interface; (b) downloading patents according to the patent downloading conditions from a remote database through a network; (c) storing the patents in a local database; (d) setting patent family downloading conditions; (e) downloading patent family data according to the patent family downloading conditions from a patent family database through the network; (f) storing the patent family data in the local database; (g) setting patent family analysis conditions; and (h) analyzing the patent family data according to the patent family analysis conditions.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware configuration of a patent family analyzing system in accordance with a preferred embodiment of the present invention, with two client computers of the system shown;

FIG. 2 is a block diagram of main function units of the patent family analyzing system of FIG. 1, but showing only one of the client computers;

FIG. 3 is a flowchart of a preferred method for implementing the patent family analyzing system of the present invention; and

FIG. 4 is a flowchart of a preferred method for downloading patent family data according to the present invention.

### DETAILED DESCRIPTION OF THE INVENTION

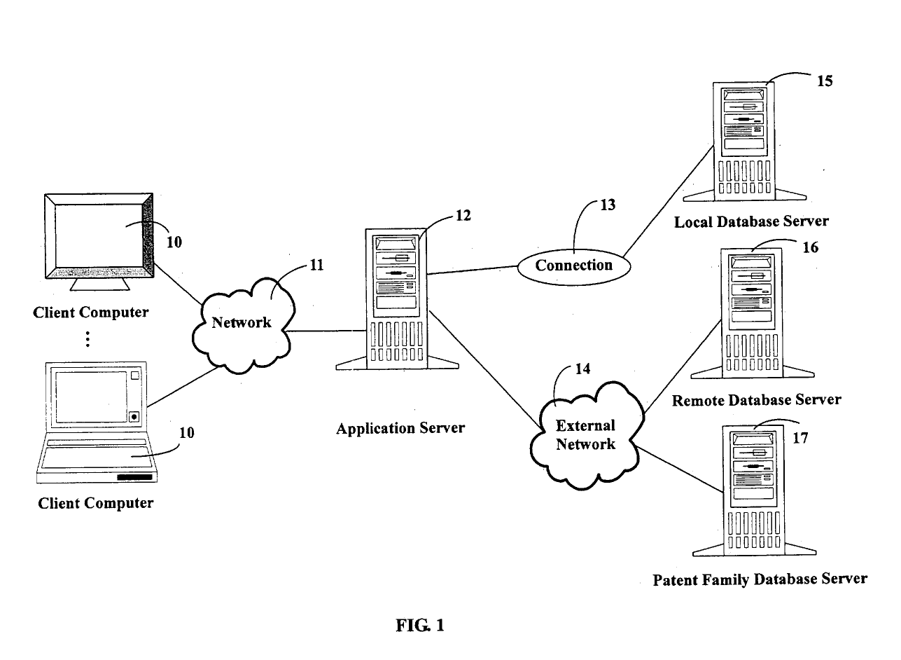

FIG. 1 is a schematic diagram of hardware configuration of a patent family analyzing system in accordance with a preferred embodiment of the present invention. The patent family analyzing system includes a plurality of client computers 10 (only two shown), an application server 12, a local database server 15, at least one remote database server 16 (only one shown), and a patent family database server 17. The client computers 10 are connected to the application server 12 through a network 11. The application server 12 is connected to the local database server 15 through a connection 13. The connection 13 is database connectivity such as ODBC (Open Database Connectivity) or JDBC (Java Database Connectivity). The application server 12 is connected to the remote database server 16 and the patent family database server 17 via an external network 14, which may for example be the Internet. The local database server 15 stores data downloaded from the remote database server 16 and the patent family database server 17. The application server 12 accesses publicly available patents from the remote database server 16, and accesses patent family data from the patent family database server 17.

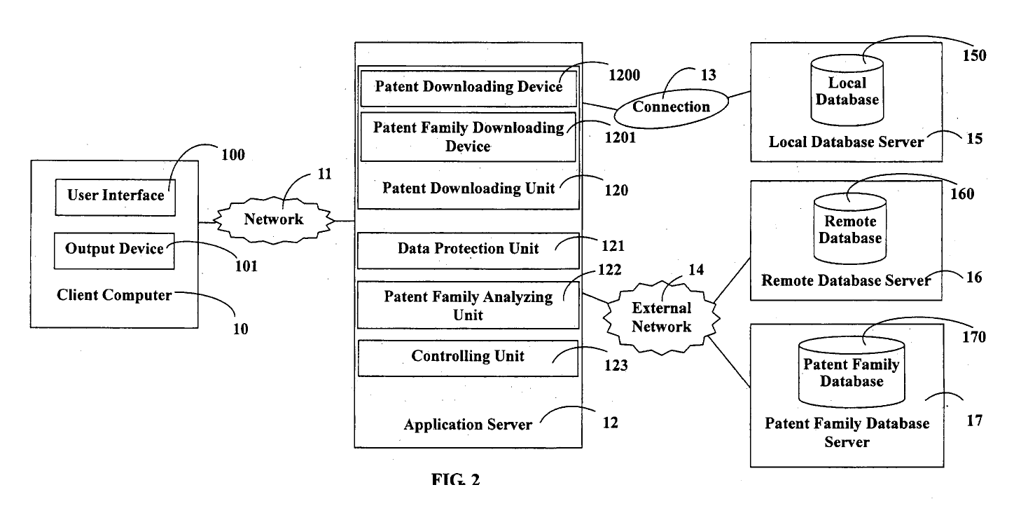

FIG. 2 is a block diagram of main function units of the patent family analyzing system, but showing only one of the client computers 10. The client computer 10 comprises a user interface 100 and an output device 101. The user interface 100 is an interactive interface for implementing operations such as protecting company data, setting patent family downloading conditions, and setting patent family analysis conditions. The output device 101 is used for displaying analysis results of patent families in the form of words, diagrams or tables. The local database server 15 comprises a local database 150, which stores at least one set of company names. Each company name set comprises names of all companies that belong to a same corporate group.

The application server 12 comprises a patent downloading unit 120, a data protection unit 121, a patent family analyzing unit 122, and a controlling unit 123. The patent downloading unit 120 comprises a patent downloading device 1200, and a patent family downloading device 1201. The patent downloading device 1200 is used for automatically downloading patents and other detailed data from any remote database 160. Other detailed data includes information such as patent numbers, patent names, patent abstracts, patent priorities, patent assignees, patent specifications, and patent figures. Each remote database 160 is an official database of a particular patent jurisdiction. In most cases, each database 160 belongs to a government patent office. Such offices may include, for example, the United States Patent and Trademark Office, the European Patent Office and the State Intellectual Property Office of the People's Republic Of China (PRC). The remote databases 160 invariably provide patent searching tools at their respective websites, through which a user can set one or several characters as key words to search for corresponding patents. In the preferred embodiment of the present invention, the user can set patent downloading conditions through the user interface 100 in the much the same way as the websites do. The patent downloading device 1200 applies for searching of patents in one remote database server 16 according to the downloading conditions via the network 14. The search results are returned to the patent downloading unit 120, and stored in the local database 150 through the connection 13. The user can examine the list of downloaded patents, classify the patents, and store the classifications in the local database 150 through the user interface 100.

The patent family downloading device 1201 is used for downloading patent family data from any patent family database server 17. Each patent family database server 17 comprises a patent family database 170 typically storing vast amounts of patent family data, such as the patent family database of LexisNexis Corporation. After all patents are downloaded in the patent downloading device 1200, the patent family downloading device 1201 downloads patent family data typically according to patent number or company name, and in accordance with downloading conditions set through the user interface 100.

If the user chooses to download patent family data by patent number, the patents downloaded through the patent downloading unit 120 are listed according to patent number, and displayed for the user via the user interface 100. The user selects patent numbers whose patent family data need to be downloaded, or sets selection conditions for patent family data to be downloaded. If the user wants to analyze patents that have been classified, he can select all patents that belong to a same classification by setting the classification as one of the selection conditions. Thereupon, the patent family downloading device 1201 automatically creates a search sentence according to the selected patents, and transmits the search sentence to the patent family database server 17. The patent family database server 17 searches in the patent family database 170 for each patent's patent family. For each patent family, the patents involved have a common patent priority. The patents are called members of the patent family, and the common patent priority is called a basic patent. The returned patent family data include basic data on all members of the patent family and the basic patent.

If the user chooses to download patent family data by company name, the patents downloaded through the patent downloading unit 120 are arranged according to patent assignees, and are displayed for the user via the user interface 100. Thereupon, the user selects company names whose patent family data need to be downloaded. For each selected company, if there is a company name set that relates to the selected company in the local database 150, the user selects one or more of company names from the company name set as a corporate grouping. The patent family downloading device 1201 automatically creates a search sentence according to the corporate grouping, and transmits the search sentence to the patent family database server 17. If there is no company name set that relates to the selected company in the local database 150, the patent family downloading device 1201 automatically creates a search sentence according to the selected company name, and transmits the search sentence to the patent family database server 17. The patent family database server 17 searches in the patent family database 170 for patent family data according to the corporate grouping or the selected company. The returned patent family data are arranged according to corporate grouping name or company name. For each company, the patent family data are arranged according to patent number. Each patent number relates to a set of patent family data, and comprises all members of the patent family and the basic patent.

The data protection unit 121 is used for searching, adding, modifying or deleting a company name set or company names in a particular company name set.

The patent family analyzing unit 122 is used for creating analysis results according to analysis conditions set by a user. The analysis conditions are first translated into a search sentence that can be identified by the local database 150. Then the search sentence is transmitted to the local database server 15. The local database server 15 searches in the local database 150 for corresponding patent family data, and returns search results to the patent family analyzing unit 122. For instance, a user may want to obtain a contrast analysis of patent families of a particular collection of competing companies in a particular technological field. The user first selects the competing companies through the user interface 100, and sets the technological field. Suppose that the technological classification related to the technological field is A. The analysis conditions are translated into a search sentence in the patent family analyzing unit 122. Then, the local database server 15 searches for patent family data on the competing companies according to the search sentence, and selects patent family data on each company according to their technological classifications. If a patent's technological classification is A, the patent family data on the patent is included in the search results. When patent family data on all required companies in the technological field are found, the search results are returned to the patent family analyzing unit 122, and are arranged according to company name. The patent family analyzing unit 122 analyzes patent family data on each company according to patent jurisdictions, and transmits the results to the controlling unit 123.

The controlling unit 123 is used for controlling the patent downloading unit 120, the data protection unit 121 and the patent family analyzing unit 122, and for coordinating interaction between the user and the patent family analyzing system. The controlling unit 123 accepts downloading conditions set by the user, and transfers the downloading conditions to the patent downloading unit 120. The controlling unit 123 accepts returned results from the patent downloading unit 120. The returned results are displayed to the user via the user interface 100, and stored in the local database 150. The controlling unit 123 accepts analysis conditions, and transfers the analysis conditions to the patent family analyzing unit 122. The controlling unit 123 accepts analysis results from the patent family analyzing unit 122, and transfers the analysis results to the client computer 10.

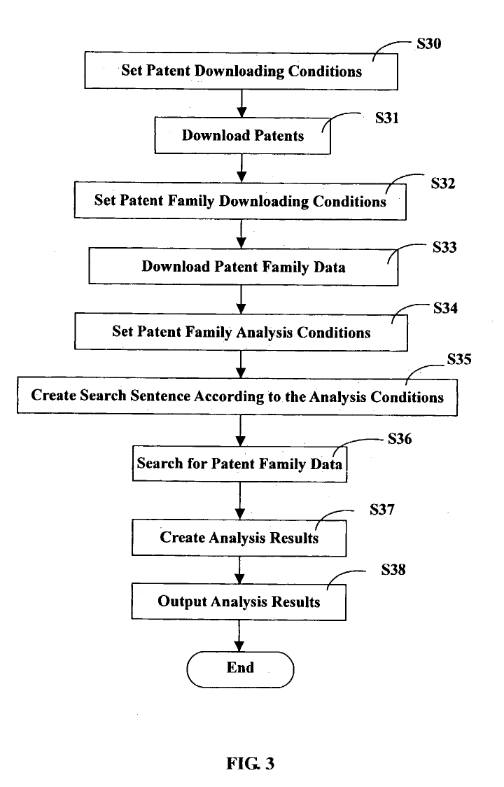

FIG. 3 is a flowchart of a preferred method for implementing the patent family analyzing system of the present invention.

In step S30, a user sets patent downloading conditions through the user interface 100.

In step S31, the patent downloading conditions are transmitted to the patent downloading device 1200 through the controlling unit 123. The patent downloading device 1200 automatically downloads patents from the relevant remote database 160 according to the patent downloading conditions.

In step S32, the user sets patent family downloading conditions through the user interface 100.

In step S33, the patent family downloading device 1201 downloads patent family data from the patent family database 170 according to the patent family downloading conditions.

In step S34, the user sets patent family analysis conditions.

In step S35, the patent family analysis conditions are transmitted to the patent family analyzing unit 122 through the controlling unit 123, and translated into a search sentence that can be identified by the local database 150.

In step S36, the search sentence is transmitted to the local database server 15. The local database server 15 searches in the local database 150 for corresponding patent family data, and returns search results to the patent family analyzing unit 122.

In step S37, the patent family analyzing unit 122 analyzes the returned patent family data, and creates analysis results.

In step S38, the analysis results are transmitted to the client computer 10 through the controlling unit 123, and displayed in the form of words, figures or tables through the output device 101.

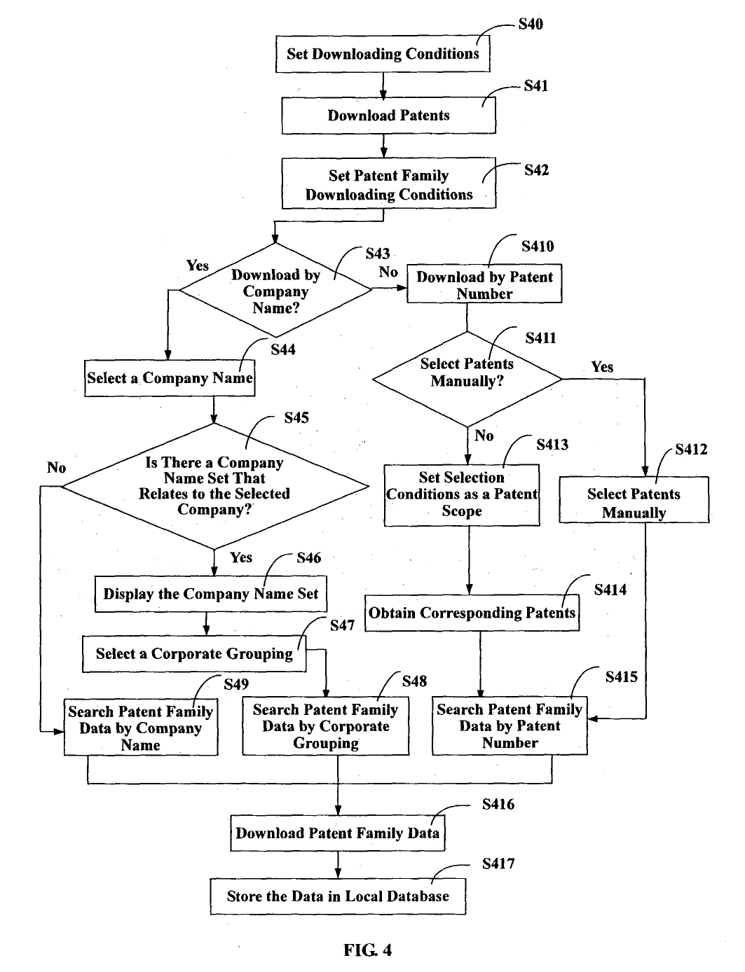

FIG. 4 is a flowchart of a preferred method for downloading patent family data according to the present invention.

In step S40, the user sets patent downloading conditions through the user interface 100.

In step S41, a search sentence is created in the patent downloading device 1200 according to the patent downloading conditions, and transmitted to the remote database server 16 via the network 14. The remote database server 16 searches the relevant remote database 160 for corresponding patents. The search results are returned to the patent downloading device 1200, and stored in the local database 150 via the controlling unit 123.

In step S42, the user sets patent family downloading conditions through the user interface 100.

In step S43, the user decides whether to download patent family data by company name.

If the user decides to download patent family data by company name, in step S44, patent assignees related to the downloaded patents are displayed for the user in a list. The user selects one or more company names whose patent family data need to be downloaded.

In step S45, the patent family analyzing system ascertains whether there is any corresponding company name set that relates to any selected company.

If there is a corresponding company name set related to any selected company, in step S46, the company name set is automatically displayed.

In step S47, the user selects one or more company names from the company name set as a corporate grouping.

In step S48, the patent family downloading device 1201 searches for patent family data according to the corporate grouping.

If in step S45 there is no company name set that relates to the selected company, in step S49, the patent family downloading device 1201 searches for patent family data according to all selected company names.

If in step S43 the user does not want to download patent family data by company name, in step S410, the patent downloading device 1201 downloads patent family data by patent number. The patents downloaded are displayed according to patent number.

In step S411, the user decides whether to select patents manually.

If the user decides to select patents manually, in step S412, the user selects relevant patents.

In step 415, the patent family downloading device 1201 searches for patent family data on the selected patents by patent number.

If in step S411 the user does not decide to select patents manually, in step S413, the user sets selection conditions as a patent scope.

In step S414, corresponding patents are obtained from the patents downloaded in step S41 according to the selection conditions.

In step S415, the patent family downloading device 1201 searches for and downloads patent family data on the obtained patents according to patent number.

In step S416, a search sentence is created in the patent family downloading device 1201 according to company name as per step S49, or according to corporate grouping as per step S48, or according to patent number as per step S415. The search sentence is transmitted to the patent family database server 17 via the network 14. The patent family database server 17 searches for and downloads corresponding patent family data in the patent family database 170 according to the search sentence.

In step S417, the patent family data are transmitted to the patent family analyzing unit 122 via the network 14, and stored in the database 150 via the controlling unit 123.

Although the present invention has been specifically described on the basis of a preferred embodiment and preferred methods, the invention is not to be construed as being limited thereto. Various changes or modifications may be made to said embodiment and methods without departing from the scope and spirit of the invention.

What is claimed is:

1. A system for analyzing patent families, the system comprising:
a plurality of client computers, each of the client computers including an interactive user interface enabling a user to set downloading conditions and analysis conditions for a patent family;
a local database for storing downloaded patents and patent family data; and
an application server comprising:
a patent downloading unit for automatically downloading patents from at least one remote database according to patent downloading conditions, and for downloading patent family data from a patent family database according to patent family downloading conditions;
a patent family analyzing unit for analyzing a patent family according to analysis conditions set for the patent family; and
a controlling unit for controlling operations of the patent downloading unit and the patent family analyzing unit, and for coordinating interactions between the user and the patent downloading unit and the patent family analyzing unit.

2. The system according to claim 1, further comprising a data protection unit for searching, adding, modifying or deleting a company name set or company names in a particular company name set.

3. The system according to claim 1, wherein each of the client computers comprises an output device for displaying analysis results of patent families.

4. The system according to claim 1, wherein the client computers are connected to the application server via a network.

5. The system according to claim 1, wherein the application server is connected to the local database through database connectivity.

6. A method for analyzing patent families, the method comprising the steps of:
(a) setting patent downloading conditions through a user interface;
(b) downloading patents according to the patent downloading conditions from a remote database through a network;
(c) storing the patents in a local database;
(d) setting patent family downloading conditions;
(e) downloading patent family data according to the patent family downloading conditions from a patent family database through the network;
(f) storing the patent family data in the local database;
(g) setting patent family analysis conditions; and
(h) analyzing the patent family data according to the patent family analysis conditions.

7. The method according to claim 6, further comprising the step of:
displaying the analysis results through the user interface.

8. The method according to claim 6, wherein step (d) comprises the steps of:
(d1) deciding whether to download patent family data by company name or by patent number;
(d2) displaying patent assignees of downloaded patents if patent family data are to be downloaded by company name;
(d3) selecting company names whose patent family data need to be downloaded;
(d4) displaying patent numbers of downloaded patents if patent family data are to be downloaded by patent number; and
(d5) selecting patent numbers whose patent family data need to be downloaded, or setting selection conditions as the scope of patent family data to be downloaded.

9. The method according to claim 8, wherein step (d3) comprises the steps of:
(d31) selecting a company name;
(d32) if there is a company name set that relates to the selected company in the local database, selecting one or more of company names from the company name set as a corporate grouping; and
(d33) repeating the above steps until all company names whose patent family data need to be downloaded are selected.

10. The method according to claim 6, wherein step (h) comprises the steps of:
(h1) creating a search sentence according to the patent family analysis conditions;
(h2) searching in the local database for corresponding patent family data; and
(h3) analyzing the corresponding patent family data.

11. A method of managing patent data, comprising:
(1) downloading patents form a remote patent database via a network;
(2) setting patent family download conditions;
(3) setting two search routes including under company names and under patent numbers, wherein there are individual and group categories under the company names, and there are manually search and automatic conditions search under the patent numbers; and
(4) integrating and analyzing results of step (3).
